(19) United States
(12) Patent Application Publication
(10) Pub. No.: US 2011/0311362 A1
(43) Pub. Date: Dec. 22, 2011

(54) Compound Steel Bearings and Methods of Manufacturing

(76) Inventor: Jochen Corts, Remscheid (DE)

(21) Appl. No.: 13/133,137

(22) PCT Filed: Dec. 4, 2009
(86) PCT No.: PCT/IB2009/007920

§ 371 Date: Sep. 7, 2011

Related U.S. Application Data
(62) Division of application No. 61/119,873, filed on Dec. 4, 2008.

(51) Int. Cl. F16C 33/58; B23K 15/10; F03D 11/00; B23K 31/02; F16C 43/04; F16C 33/62

(52) U.S. Cl. 416/174; 384/585; 384/569; 228/159; 219/121.14

(57) ABSTRACT

A bearing comprising a high tensile steel layer and a mild steel base layer with said layers being fused together across a fusion zone, a raceway machined across the bearing, with said raceway having a bearing support depth which is substantially greater than a bearing support depth obtainable using traditional steel hardening processes, and a retention structure machined into at least the mild steel base layer and utilized to retain the bearing to an underlying bearing support.

### TECHNICAL FIELD

The present disclosure is directed to compound steel bearings. More particularly, the disclosure relates to compound steel bearings and manufacturing processes and applications including, but not limited to, wind generators and other heavy equipment. A variety of ring and flat bearings may be manufactured utilizing aspects of the present invention.

### BACKGROUND OF THE INVENTION

Due to well known metallurgical and chemical properties, the thickness of the hardened layer, particularly when using the case hardening processes, is strictly limited. As a consequence, the bearing engineer is most often constrained by the depth of the hardened layer for a given load and/or environment. For example, FIGS. 3a, 4a and 5a illustrate various cross-sectional views taken through steel bearing raceways with the hardness patterns indicated as “hp”. The depth of the hardened steel is limited, particularly with induction-hardened raceways.

Prior to the present invention, large bearing requirements could not fully and satisfactorily be met in a steel race, for such a large bearing, because the race metal in the vicinity of the rolling elements was either too soft or incapable of being hardened, or the metal of portions of the race in which gear teeth were to be cut or fastening means were to be machined or welded was too hard and brittle to provide fully the desired ductility, toughness and strength characteristics. If the metal portion of a bearing race to be contacted by the balls or other rotating elements is too soft because it is not hardenable to a sufficient degree this portion of the race will deform or wear or otherwise harmfully affect the characteristics of the bearing; but if the remaining metal portions of the race are too hard, they will be so brittle and subject to cracking that they will not be sufficiently strong, tough and ductile for the service they should perform and will not be capable of being machined to form structures such as gear teeth, etc., that have sufficient tensile strength and toughness or of being satisfactorily welded.

### SUMMARY OF THE INVENTION

The present invention relates to processes and products of processes for making compound steel bearings having different characteristics at different portions of the bearing, e.g., at the upper/lower or inner/outer peripheries of annular members. For example, the members may be formed as annular blanks for bearing races or the races themselves, in which at one periphery of the member the metal can be hardened, to a desired high degree of hardness and at portions away from such periphery, the metal may have substantially less hardness and greater ductility and toughness.

Embodiments of the present invention may be used for various purposes, though exceptional advantages can be attained when used in bearing races for large diameter bearings, such as bearings for supporting rotating parts of equipment such as wind towers for power generation, and when used in processes for making annular blanks out of which such bearing races are made and for making races from such blanks. Therefore the invention will be discussed in connection with such uses.

Bearing races desirably include metal that is capable of being substantially hardened and hence rendered quite brittle at and for some distance below surfaces of the grooves or raceways against which bear the balls or other rolling or sliding elements of the bearings to minimize wear. Nevertheless, such a race must also include metal away from such hard metal that is sufficiently ductile and tough and possesses sufficient tensile strength to resist the stresses, forces and shocks to which the race may be subjected in service; and often such a race must include metal sufficiently ductile, tough and strong to permit machining the periphery opposite the raceway to gear teeth that can be used to rotate the race by power means to, for example, swing portions of a wind tower, or to permit machining or welding of parts such as fastening means at locations away from the raceway.

Therefore embodiments of the present invention provide a novel bearing comprised of two or more significantly different alloys. With this solution, not only can the alloys be varied, but also the thicknesses of the through hardened zones or layers can be predetermined based on the necessities of the process or bearing application. As a result, the thickness of the through hardened layer is not limited by non-process or application based parameters like the carbon diffusion into the surfaces of roller bearing steels.

Embodiments of the present invention also relate to the production of the inner and outer races of roller bearings from dissimilar compound materials. In some embodiments, basic compound rings can be ring-rolled to the desired diameters, while the ratio remains constant between the high alloyed bearing surface layer and the mild steel basic layer. With such a process the depth of through-hardening may not be limited by fixed carbon diffusion parameters. By the selective combination of thickness ratio between the shell and core part of a compound steel ring, the characteristics of the rings can be predetermined based on the requirements of the application and/or anticipated environment of use.

Embodiments of the invention are particularly applicable for larger bearings, where the ratio between the through-hardened layer and the base material continues to decrease with an increasing diameter (due to the limited hardening depth). A competing consideration is that the desired loads of these large bearings continues to increase with the diameter.

Prior art solutions for large diameter bearings include multi-row bearings having increased in size and weight In comparison, load-equivalent large bearing embodiments of the present invention would be significantly lighter and stronger as multiple rows of bearings may not be required.

Embodiments of the present invention concern bearings for the transmission of high axial forces and large flexural moments with small relative movements between the co-operating bearing components. Wind power installations would benefit with such a compound bearing between its pylon-supported machine head and the pylon head.

Bearings of the present invention involving the demand profile as specified above can be used for example as pivot bearings in cranes, certain leisure and pleasure installations and indeed wind power installations (as so-called azimuth bearings). In that respect, a structural problem arises out of the fact that, even in the case of a vertical rotary axis, the forces, both in the direction of an applied load and also in the lifting-off direction, have to be carried by the bearing.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 is a top plan view of a compound steel roller bearing in accordance with the present invention.

FIG. 2 is a cross-sectional view of the bearing of FIG. 1.

FIG. 3a-3b are cross-sectional views of bearing raceways providing a comparison between prior art raceways and a raceway in accordance with the present invention.

FIG. 4a-4b are cross-sectional views of bearing raceways providing a comparison between prior art raceways and a raceway in accordance with the present invention.

FIG. 5a-5b are cross-sectional views of bearing raceways providing a comparison between prior art raceways and a raceway in accordance with the present invention.

FIG. 6 is a cross-sectional view of another embodiment of a bearing in accordance with the present invention.

FIG. 7 is a cross-sectional view of another embodiment of a bearing in accordance with the present invention.

FIG. 8 depicts a manufacturing process of a portion of the bearing of FIG. 7.

FIG. 9 depicts another manufacturing process of a portion of the bearing of FIG. 7.

FIG. 10 depicts material processing utilized in a method of manufacturing a bearing in accordance with the present invention.

FIG. 11 depicts a method of manufacturing portions of a bearing in accordance with the present invention.

FIG. 12 depicts another method of manufacturing portions of a bearing in accordance with the present invention

FIG. 13 depicts a ring rolling process suitable for use during a method of manufacturing portions of a bearing in accordance with the present invention.

FIG. 14 depicts a ring rolling process suitable for use during a method of manufacturing portions of a bearing in accordance with the present invention.

FIG. 15 depicts a wind generator utilizing bearing technology of the present invention.

FIG. 16 depicts the interior aspects of the wind generator of FIG. 15.

FIG. 17 depicts an embodiment of a annular ring bearing utilizing aspects of the present invention and adapted for use with the wind generator of FIG. 15

### DETAILED DESCRIPTION OF THE INVENTION

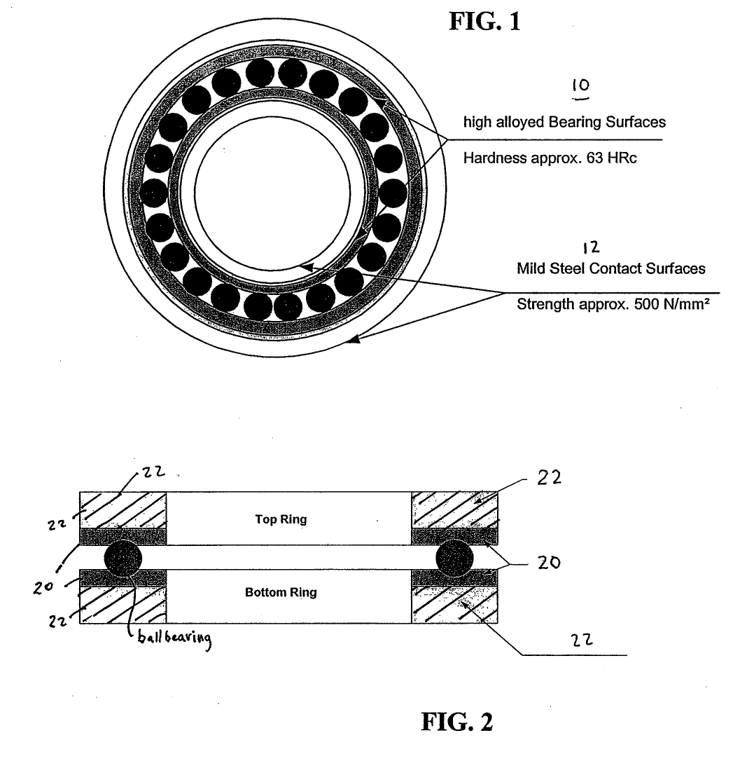

FIG. 1 illustrates a top plan view of a compound steel roller bearing in accordance with the present invention. As described in greater detail herein, the roller bearing includes high alloy bearing portions 10 and mild steel bearing portions 12.

FIG. 2 depicts a side view of a cross-section taken through an annular bearing in accordance with the present invention. Similar to the embodiment of FIG. 1, the bearing includes high alloyed layers 20 and mild steel layers 22. Such annular bearings may be particularly well suited as azimuth bearings for wind power generators.

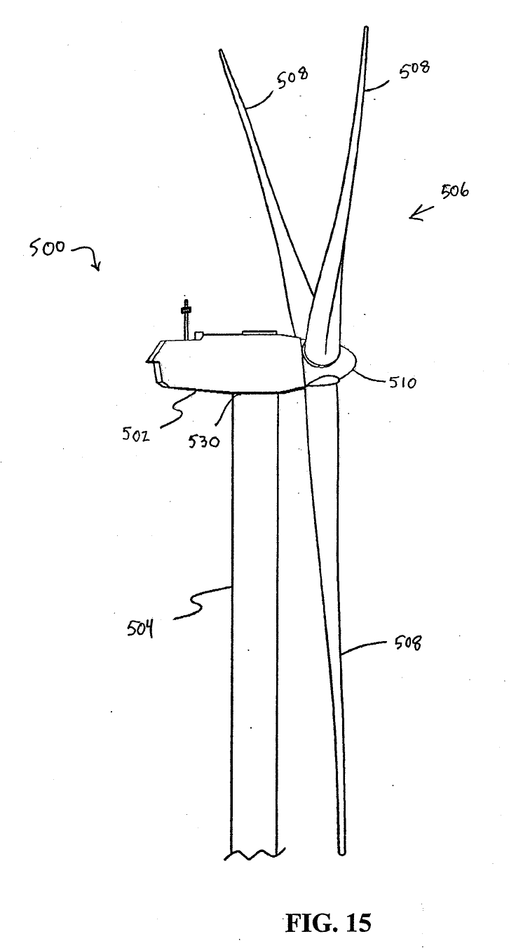

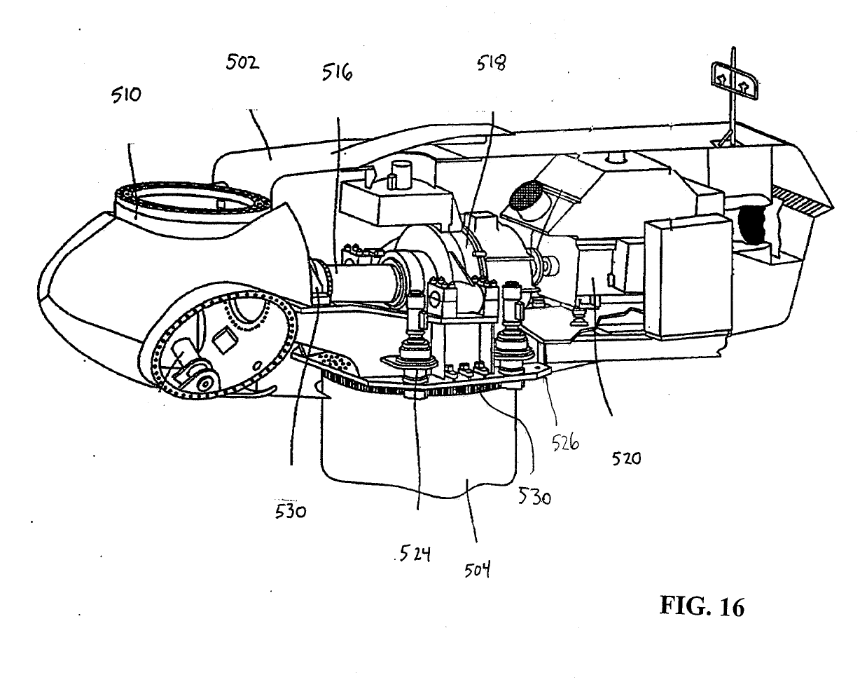

Such annular compound steel bearings are well suited for the transmission of high axial forces and large flexural moments with small relative movements between the co-operating bearing components. A wind power installation may include such a bearing between its pylon-supported machine head and the pylon head, such as disclosed in FIGS. 15-16.

Bearings of the present invention involving the demand profile as specified above can be used for example as pivot bearings in cranes or other large equipment. In another embodiment, bearings of the present invention may serve as replacements to hydrodynamic oil film bearings, such as MORGOIL bearings manufactured by the Morgan Company. Hydrodynamic bearings have been used in very high load applications like the bottom and top back-up roll chocks in rolling mills. Bearings of the present invention may also accept increased working loads in the limited space situation of work roll chocks in rolling mills.

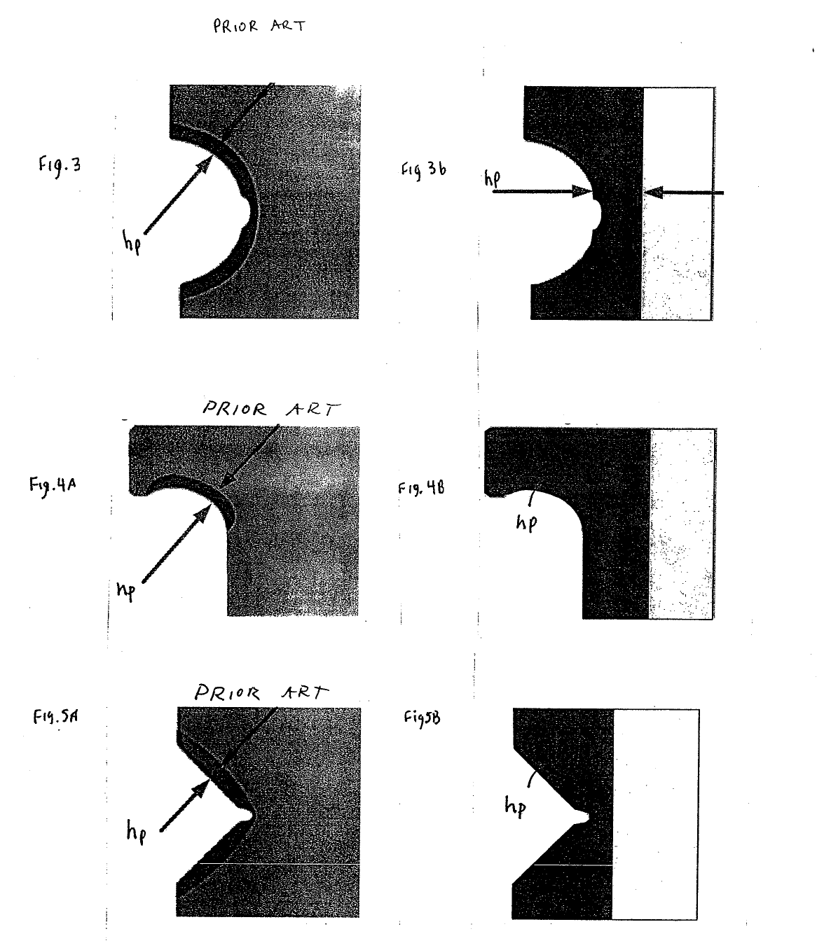

FIGS. 3-5 provide comparative illustrations between prior art raceways and raceways of bearings manufactured in accordance with the present invention. FIGS. 3A, 4A and 5A illustrate prior art raceways (taken in cross-section) having a hardened portion, hp. In comparison, FIGS. 3B, 4B and 5B illustrate raceways of bearings of the present invention wherein the hardened portions, hp, have a significantly greater depth dimension. Importantly, the depth of the hardened portions are not limited by known hardening processes, but rather a designer could select a hardened portion depth as a function of anticipated loads, etc.

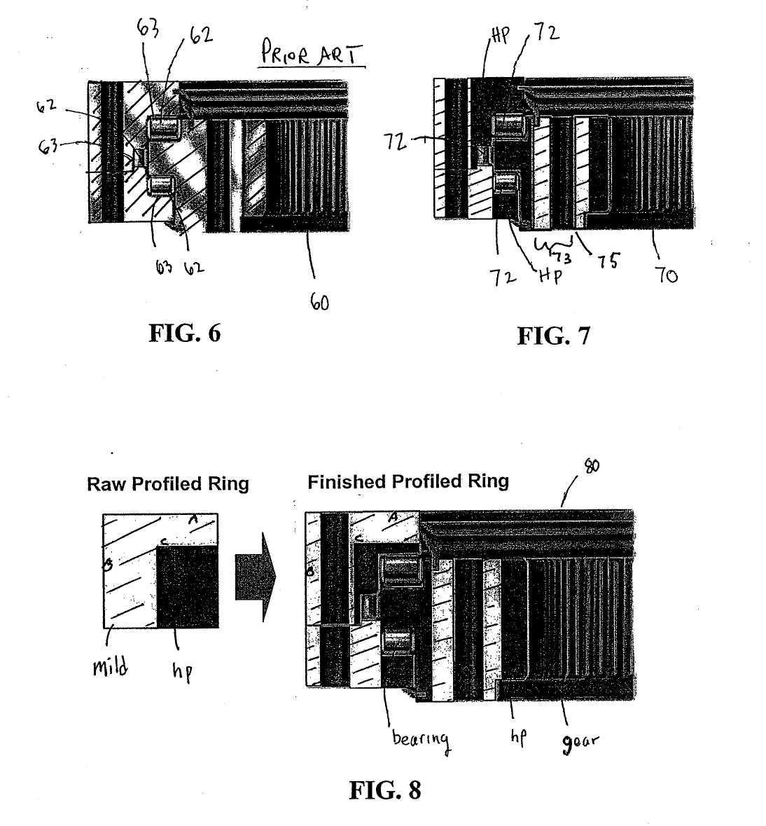

FIG. 6 depicts a cross-section taken through a prior art large gear bearing having an internal gear 60 rotating on bearings 62 in contact with outer raceway 63 of external ring 64. Again, the depth of the hardened portions of the raceways is limited as a function of known manufacturing processes. In comparison, FIG. 7 depicts a similar large gear bearing having an internal gear 70 rotating on bearings 72 in contact with raceways 73 of external ring 74. In this embodiment, entire portions of the internal and external rings are defined by hardened steel. As shown in FIG. 7, the hardened portions of the bearing are designated “hp”. A retention structure 73 includes an aperture 75 through which a fastener (not shown) is received to secure the internal gear 70 to an underlying support structure (not shown).

FIG. 8 depicts a manufacturing process through which a raw profiled ring is used to fabricate a portion of bearing 80 in accordance with the present invention.

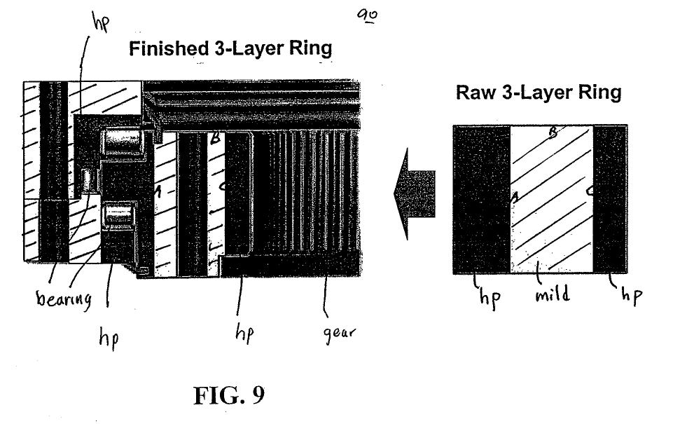

FIG. 9 depicts a manufacturing process through which a raw profiled ring is used to fabricate a portion of bearing 90 in accordance with the present invention.

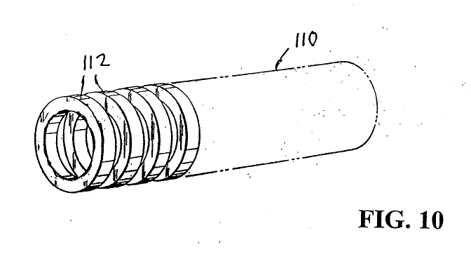

A preferred method of manufacturing a ring bearing in accordance with the present invention is disclosed with reference to FIGS. 10-14. For convenience the process will be first discussed below in connection with an outer race. In making the outer race, the first step is making a blank or billet having two or more different steel alloys. As shown in FIG. 10, the blank 110 can then be cut into annular ring members or rings 112 for subsequent working.

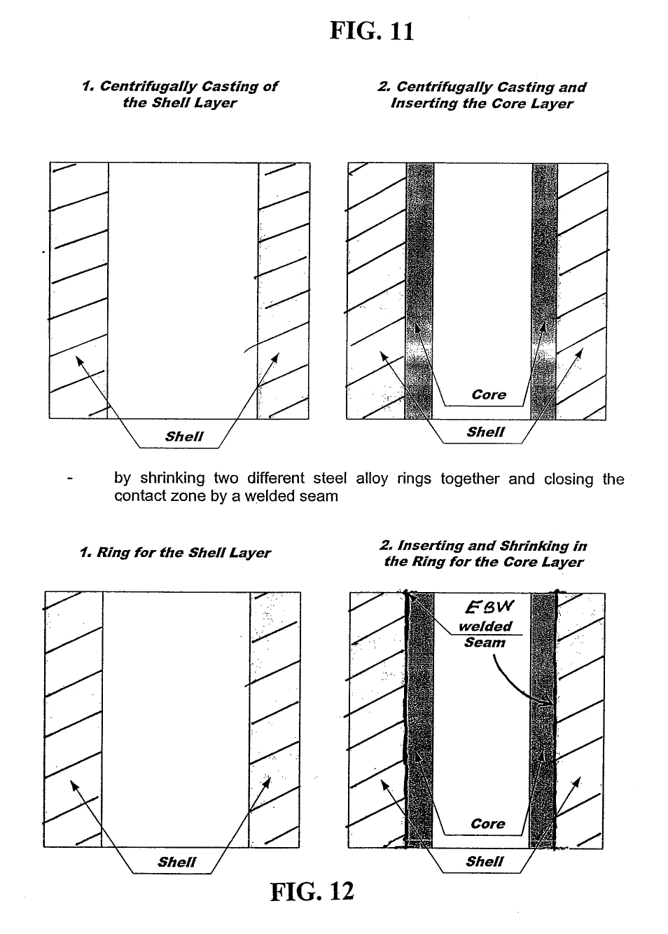

FIG. 11 discloses one approach to making a billet wherein a centrifugal casting method is used to first form a shell layer and then form a core layer. The particular alloys used in the shell and core may vary as a function of bearing application, environment, loads, etc. Through proper shell and core alloy selection, the carbon content across the ring would vary between its inner and outer periphery.

FIG. 12 discloses another approach to making a billet wherein a shell and core are welded together, such as via an electron beam welding (EBW) process. The welding process desirably creates a relatively narrow fusion zone between the shell and core elements. A particularly advantageous feature of the EBW process is that elements with vastly dissimilar characteristics can be joined.

Once the billet is formed, it is cut into annular ring members or rings 112 (FIG. 11) for subsequent working. Next, the ring can be heated to hot-working or forging temperature. Thereafter, the ring can be flattened in a conventional hydraulic press. In alternative processes, the hot-working or forging of the ring may be skipped with the ring proceeding to a cold working process.

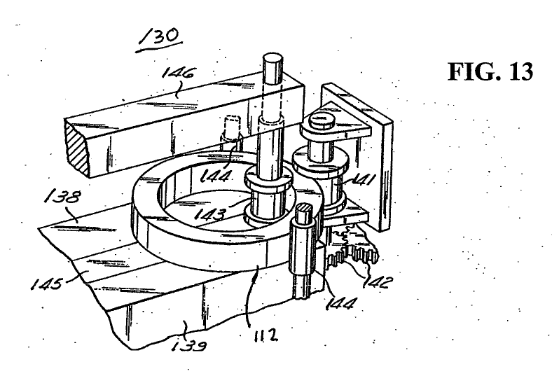

Apparatus 130 of the type indicated in FIG. 13 may advantageously be used for the roll forging or hot working. In this apparatus, the ring 112 is supported on the upper surface 138 of a base 139 and is rotated while it is pressed radially between a drive roll 141 that is positively driven by suitable drive means such as gears 142, and a freely rotatable pressure roll 143 that is pressed on the ring 112 toward the drive roll 141, the ring 112 being further guided by side rolls 144. Roll 143 is rotatably supported by upper and lower longitudinally movable members 145 and 146 that can be moved by suitable means, not shown, to cause roll 143 to press the ring 112 against the drive roll 141 with forces on the inner and outer peripheral sides of the ring sufficient to cause the desired hot working. In the apparatus illustrated, members 145 and 146 can be moved to retract the roll 143 from its pressing position, and member 146 can also be raised to lift the roll 143 from member 145 to permit a ring 112 to be inserted into and removed from the apparatus. Side rolls 144 are also movable toward and away from ring 112 to permit the ring to be put into and removed from the machine.

This hot working by roll forging around the entire circumferences of the ring substantially decreases the cross sectional thickness of the ring between its inner and outer peripheries, and substantially enlarges the diameter of the inner and outer ring peripheries. The ring thickness can be reduced to about 50 to 75 percent of the thickness before roll forging and preferably about 65 percent. The amount of roll-forging to which the ring is subjected is predetermined to accomplish the desired dimensional changes. The roll forging causes substantial reductions in the grain sizes of the ring metal for substantial distances inwardly from the inner and outer peripheries of the ring, preferably throughout the entire cross section of the ring entirely around its circumference. The substantial roll forging hot working also causes substantial orientation of the grain structure parallel to the circumferential surfaces of the ring to increase toughness and strength of the metal in the circumferential direction.

Importantly, the radial hot working closes voids that might have existed in the cast metal or welded billet and provides a more homogenous physical structure of the metal, toughens the metal, and increases its tensile strength. With a sufficient large roll forging forces, two different alloys can be metallurgically bonded together. This method of forming a compound steel ring billet is significantly less expensive than, for example, the centrifugal casting approach described above. Additionally, cores and shells of greater variability can be joined using the unique roll forging process as described above.

The ring 112 can subsequently be machined by conventional means and methods to the desired dimensions and shape. The shape of the raceway is designed in conventional manner and is machined in conventional manner. The remaining portions of the race are machined to desired shapes and dimensions by conventional means and methods; and if gear teeth are desired on the outer periphery, they are also machined. Finally, the rings 112 can subsequently heat treated using known hardening processes.

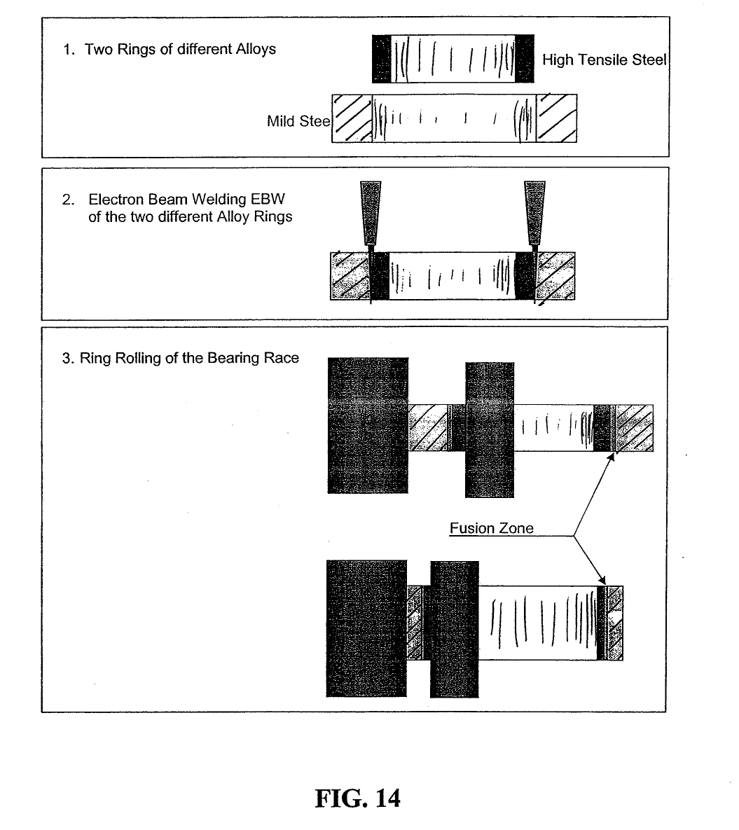

Referring now to FIG. 14, a process of forming a bearing element is disclosed. At step 1, a determination and selection of two different alloys is made. In this example, high tensile steel and mild steel rings are selected based on the bearing loads, environment of use, etc. At step 2, the two rings of different steel are welded together via an electron beam welding EBW process. A significant benefit of the EBW process is a relatively narrow and deep fusion zone. At step 3, the combined rings are processed via known ring-rolling devices in order to achieve the desired bearing thickness, diameter and height dimensions. Subsequent to this step, the bearing elements can be heat treated or machined in manners similar to prior art bearing rings.

In another bearing application, the manufacturing process begins with a compound steel plate having at least two different layers. A fusion zone exists between a high alloyed steel layer and a mild steel base. Using known flat bearing production processes, the compound steel plate can be engineered to perform in a variety of load conditions, environments, etc. For example, the thicknesses of the hard high-alloyed layer and mild steel base can be predetermined. Importantly, this design process is not limited by the ability of carbon to diffuse into the steel matrix as required in traditional hardening processes.

A unique application of large bearings manufactured in accordance with the present invention can now be described. One embodiment of the invention concerns an azimuth bearing for the transmission of high axial forces and large flexural moments with relative small movements between the bearing components, such as seen in wind power installations with the azimuth bearing supporting the machine head above the pylon head.

In its specific aspect the invention concerns a wind power installation having a plain bearing of the above-described kind between a pylon-supported machine head and the pylon head, wherein provided between the pylon head and the machine head is a tracking drive for rotation of the machine head about the vertical axis of the pylon, in dependence on wind direction, wherein the plain bearing is adapted to guide the machine head in the radial direction.

The rotary bearing which is generally referred to as an azimuth bearing makes it possible—by means of the tracking drive—to adjust the rotor which receives the wind power, in such a way that, depending on the respective wind direction, the highest level of efficiency is achieved and in addition, when the installation is stopped, the loading on all components of the installation is kept as low as possible. Usually, the rotary bearing which must be of large diameter in high-output wind power installations comprises a rotary ball-type connection. A compound steel bearing according to the invention is substantially better suited to carrying high forces when small movements are involved. The bearings in accordance with the present invention can carry vertical forces which occur in the axial direction both in the direction of an applied load and also in the lifting-off direction.

Generally, a wind turbine includes a rotor having multiple blades. The rotor is mounted to a housing or nacelle, which is positioned on top of a truss or tubular tower. Utility grade wind turbines (i.e., wind turbines designed to provide electrical power to a utility grid) can have large rotors (e.g., 30 or more meters in diameter). Blades on these rotors transform wind energy into a rotational torque or force that drives one or more generators that may be rotationally coupled to the rotor through a gearbox. The gearbox steps up the inherently low rotational speed of the turbine rotor for the generator to efficiently convert mechanical energy to electrical energy, which is fed into a utility grid.

In some configurations and referring to FIGS. 15 and 16, a wind turbine 500 comprises a nacelle 502 housing a generator (not shown in FIG. 15). Nacelle 502 is mounted atop a tall tower 504, only a portion of which is shown in FIG. 15. Wind turbine 500 also comprises a rotor 506 that includes one or more rotor blades 508 attached to a rotating hub 510. Although wind turbine 500 illustrated in FIG. 15 includes three rotor blades 508, there are no specific limits on the number of rotor blades 508 required by the present invention. The drive train of the wind turbine includes a main rotor shaft 516 (also referred to as a “low speed shaft”) connected to hub 510 via main bearing 530 and (in some configurations), at an opposite end of shaft 516 to a gear box 518. Gear box 518 drives a high speed shaft of generator 520. In other configurations, main rotor shaft 516 is coupled directly to generator 520. Yaw drive 524 and yaw deck 526 provide a yaw orientation system for wind turbine 500. A large azimuth bearing 530 is positioned between yaw deck 526 and tower 504.

The efficiency of a wind turbine depends on many parameters including the orientation of the nacelle, or more specifically the location of the rotor plane with respect to the direction of the air stream. This is typically controlled by the yaw drive or azimuth-drive, which orients the nacelle into the wind. In modern wind turbines electrical and mechanical components form a yaw drive. More specifically, an electric high-speed drive motor is coupled by a gear reducer having a drive pinion gear engaging a bull gear. Usually the electric drive motor, the gear reducer, and the drive pinion gear are mounted on the nacelle's bedplate while the bull gear is fixed to the tower.

It will thus be observed that configurations of the present invention provide wind turbines with bearings that are cost effectively manufactured. Moreover, some configurations of the present invention will also be observed to provide other advantages, such as light weight construction.

In a novel bearing manufacturing process in accordance with the present invention, includes steps of identifying the loads at relevant areas of the bearing and selecting appropriate alloys for use within the identified areas in view of load conditions, environment, etc. Ideally two or more different alloys are selected for use within the bearing. The different alloys can be pre-fused together via friction fit or the above described EBW process. The alloyed elements are then fused together in an appropriate ring rolling process. Alternatively, for some bearings the alloyed elements can simply be fused via the EBW process. Subsequent to the fusing process, the blanks can be machined and/or heat treated to suit the particular application or environment.

Various modifications can be made in the processes and products described above. For example, the compressive or upsetting hot working may be carried out after, rather than before, the roll forging as described above, or both before and after the roll forging hot working. Moreover, it is possible under certain circumstances to omit completely the upsetting hot working, although in general it is beneficial in providing hot working transverse to the hot working provided by the roll forging. Furthermore, a ring of greater width can be cast and hot worked by roll forging and, then after cooling, be cut into more than one ring blank out of each portion a bearing race may be provided.

Furthermore, depending on characteristics desired, the races after machining and hardening of the raceways, may be given no further treatment, or may be given additional heat treatment over part or all of the metal away from the raceways. For example, the gear teeth cut into a race may be case hardened by known methods and means. As another example, all the metal away from the raceways may be moderately hardened by known means and methods as to impart moderate hardness to gear teeth, or a combination of such moderate hardening and case hardening of gear teeth can be used.

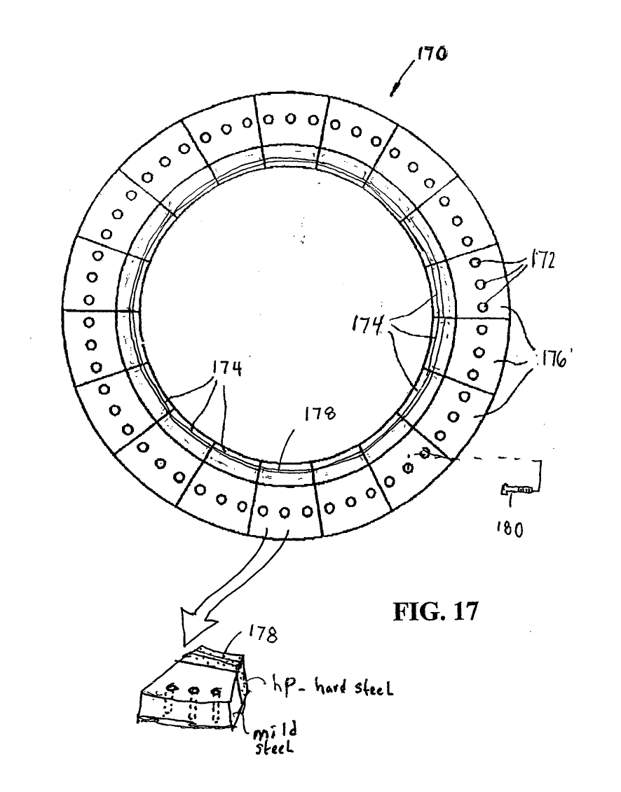

Furthermore, while ball bearings and their races are discussed above, it is apparent that the invention is applicable to roller or other types of bearings and their races. For example, FIG. 17 illustrates a bottom half portion of an azimuth bearing 170 manufactured in accordance with the present invention which has been segmented so as to permit more efficient installation, repair or replacement after damage. Bearing 170 include mounting apertures 172 through which fasteners (not shown) are used to secure the bearing segments to a frame or other structure. As described above, portions of each bearing segment may have a high-alloyed region and a mild steel base. In the bearing 170 of FIG. 17, the high alloyed region is designated 174 and a mild steel base is designated 176. An annular groove 178 is cut into the hardened portion, hp, and a plurality of roller balls (not shown) can move within the groove 178. A plurality of fasteners 180 would be used to secure the bearing 170 to its support. A top half of the azimuth bearing 170 could be substantially identical to that shown in FIG. 17. It would be appreciated that a variety of different segment configurations could be utilized to practice different bearing types.

While most of the above disclosures involve the use of steel of different carbon contents, it is apparent that steels of alloying ingredients other than those discussed above may be used and cast and worked according to the present invention, and that blanks produced according to the present invention may be used for purposes other than races of the bearings illustrated.

Although the present invention and its advantages have been described in detail, it should be understood that various changes, substitutions and alterations can be made herein without departing from the spirit and scope of the invention. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the following claims are intended to include within their scope such processes, machines, manufacture, compositions of matter, means, methods, or steps.

1. A method of forming a composite bearing comprising:
selecting a high tensile steel layer having bearing properties sufficient to carry a desired bearing load;
selecting a mild steel base layer with at least an enhanced ductility relative to the high tensile steel layer;
fusing the high tensile steel layer to the mild base layer, said fusing creating a fusion zone between the layers;
machining at least a portion of the high tensile steel layer into a configuration adapted to engage a bearing element;
machining the mild steel base layer into a configuration adapted to support the high tensile steel layer upon a base surface of an external machine, to create a plurality of bearing segments; and
joining the plurality of bearing segments together to create the composite bearing.

2. The method of claim 1 wherein said fusing includes one or more of: a ring rolling process or an electron-beam-welding process.

3. The method of claim 1 further comprising:
hardening at least a portion of the high tensile steel layer subsequent to said machining.

4. (canceled)

5. The method of claim 1 wherein the composite bearing defines a ring bearing.

6. The method of claim 5 wherein the ring bearing is an azimuth bearing adapted to movably support a portion of a wind turbine.

7. A composite bearing comprising:
a plurality of bearing segments with each bearing segment comprising a high tensile steel layer and a mild steel base layer, said layers being fused together across a fusion zone;
a raceway machined across each of the plurality of bearing segments, with said raceway having a bearing support depth which is greater than a bearing support depth obtainable using traditional steel hardening processes; and
a retention structure machined into at least the mild steel base layer, said retention structure utilized to retain each of the plurality of bearing segments to an underlying bearing support.

8. The composite bearing of claim 7 wherein the raceway is semi-circular and is adapted to accept a plurality of bearings.

9. The composite bearing of claim 8 wherein the plurality of bearings includes a plurality of roller bearings.

10. The composite bearing of claim 7 wherein the retention structure includes a plurality of open-ended cavities though which a plurality of threaded fasteners are received to secure each of the plurality of bearing segments to said underlying bearing support.

11. The composite bearing of claim 8 wherein the underlying base support is adapted to be connected to a base of a wind turbine, with the composite bearing defining a ring bearing supporting at least a rotating component of the wind turbine.

12. A composite bearing for a wind turbine including a yaw deck, a support tower and a yaw drive adapted to rotate the yaw deck relative to the support tower, said composite bearing comprising:
a segmented ring bearing comprising a plurality of bearing segments, with each bearing segment comprising a high tensile steel layer and a mild steel base layer, said layers being fused together to define a fusion zone therebetween, and wherein said high tensile steel layer defines a bearing support region which is deeper than a depth of a bearing support region utilizing traditional steel hardening processes, and each of said plurality of bearing segments are machined to define a common bearing raceway when the plurality of bearing segments are brought together as an assembly; and
a plurality of spherical or non-spherical bearing components adapted to move within said common bearing raceway, wherein the composite bearing is adapted such that a load applied by or to said yaw deck is capable of being transferred through said plurality of bearing components to the support tower.

13. The composite bearing of claim 12 wherein the layers of the bearing segments are fused together during a ring rolling process, an electron-beam-welding process, or other known steel fusing processes.

14. The composite bearing of claim 12 wherein gear portions are machined into each of the bearing segments, and together said plurality of gear portions defining a ring gear.

15. The composite bearing of claim 12 wherein the common bearing raceway extends across the high tensile steel layer of the plurality of bearing segments when said plurality of bearing segments are brought together as the assembly.

16. The composite bearing of claim 7 wherein the raceway is machined across the high tensile steel layer of each of the plurality of bearing segments.
